(19) United States
(12) Patent Application Publication
(10) Pub. No.: US 2004/0064709 A1
(43) Pub. Date: Apr. 1, 2004

(54) Security apparatus and method

(76) Inventor: James G. Heath, Catskill, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/261,882

(22) Filed: Sep. 30, 2002

(51) Int. Cl. H04L 9/00

(52) U.S. Cl. 713/186

(57) ABSTRACT

An apparatus and method of security is disclosed. The apparatus for determining a primary location and an identity of at least one person, comprising at least one sensor, wherein the at least one sensor provides a current location and at least one identifying characteristic about at least one person to a match validation system. The method for determining the primary location and the identity of the at least one person is also disclosed. The method comprises the steps of: providing a current location of at least one sensor and at least one identifying characteristic of at least one person to a match verification system; and matching the at least one identifying characteristic of the at least one person and the at least one verified identifying characteristic; and verifying the match.

### BACKGROUND OF THE INVENTION

1. Technical Field

This invention generally relates to security devices and methods of use, and more specifically relates to personal identification devices and methods of use.

2. Related Art

Identity verification systems are known in the art. Black disclosed an identity verification system employing biometric technology for identity verification in U.S. Pat. No. 6,307,956.

Houvener disclosed an identity verification system in U.S. Pat. No. 5,657,389, comprising a point of identity verification terminal having a means for inputting data presented by a particular individual, at least one database storage and retrieval site having stored therein a plurality of digital image data unique to persons to be identified, and a means for exchanging data between the point of verification terminal and the database site.

Saylor et al. disclosed a security system for a site in U.S. Pat. No. 6,400,265, employing comparison of images of the site.

There is a need for a security device that may be used for various applications.

### SUMMARY OF THE INVENTION

The present invention provides an apparatus, comprising:

at least one sensor, wherein the at least one sensor provides the following information about the at least one person to a sensor validation system:

a current location; and

at least one identifying characteristic;

a data base having the following information about the at least one person:

a primary location that includes a location where the at least one person resides; and

one or more verified identifying characteristics; and

a match verification system, wherein the primary location and an identity of the at least one person is determined by matching the at least one identifying characteristic and the one or more verified identifying characteristics and verifying the match.

A second embodiment of the present invention provides a personal identification and location system, comprising:

an information source module having at least one sensor that provides the following to a sensor validation system:

a current location; and

at least one identifying characteristic;

a data base having the following information about the at least one person:

a primary location that includes a location where the at least one person resides; and

at least one verified identifying characteristic; and

a match verification system having a processor, wherein the processor stores:

the current and primary locations, the at least one identifying characteristic from the sensor validation system and the at least one verified identifying characteristic in the data base; and

identifies the at least one person by matching the at least one identifying characteristic of the at least one person and the at least one verified identifying characteristic of the at least one person; and

verifies the match.

A third embodiment of the present invention provides a method for identifying and locating at least one person, comprising:

providing a current location of at least one sensor;

providing at least one identifying characteristic of the at least one person to a match verification system;

providing a data base having the following information about the at least one person:

a primary location that includes a location where the at least one person resides; and

at least one verified identifying characteristic;

matching the at least one identifying characteristic of the at least one person and the at least one verified identifying characteristic; and

verifying the match.

### BRIEF DESCRIPTION OF THE DRAWINGS

FIG. 1A depicts a personal identification and location apparatus, in accordance with embodiments of the present invention;

FIG. 1B depicts FIG. 1A after a user interface has been interfaced to the personal identification and location apparatus;

FIG. 1C depicts FIG. 1B, after one or more user interfaces have been interfaced to the match verification system of the personal identification and location apparatus;

FIG. 2A depicts a method for identifying and locating a person, in accordance with embodiments of the present invention; and

FIG. 2B depicts sensor validation, in accordance with embodiments of the present invention.

### DETAILED DESCRIPTION OF THE EMBODIMENTS

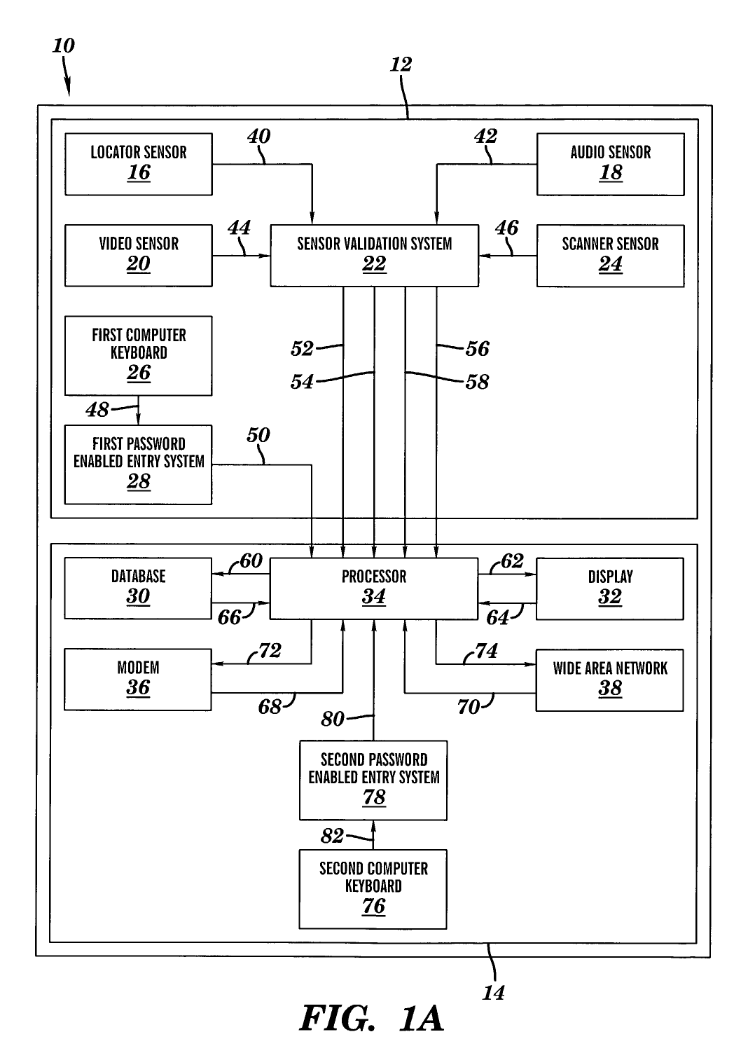

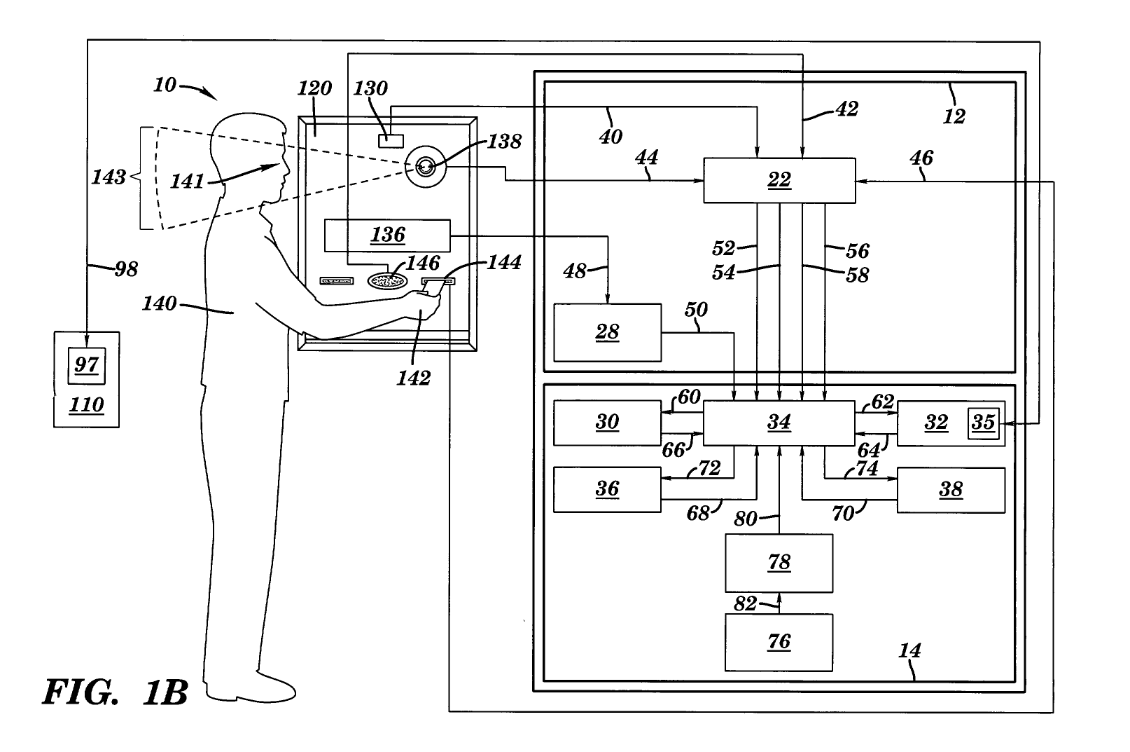

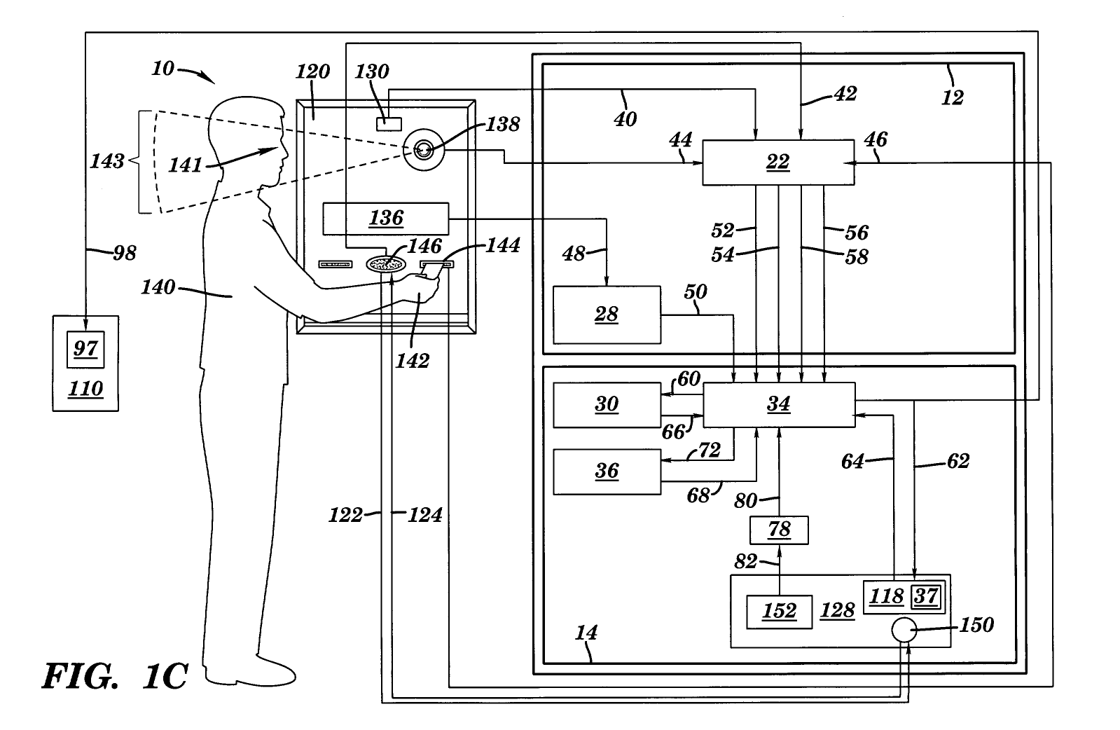

FIG. 1A depicts an apparatus 10 for identifying and locating at least one person, comprising: at least one sensor 16, 18, 20, 24 in an information source module 12, wherein the at least one sensor 16, 18, 20, 24 provides the following information about the at least one person to a sensor validation system 22 in the information source module 12: a current location, provided by a locator sensor 16; and at least one identifying characteristic, provided by an audio sensor 18, a video sensor 20 and a scanner sensor 24; a data base 30 having the following information about the at least one person: a primary location that includes a location where the at least one person resides; and at least one verified identifying characteristic; and a match verification system 14, wherein the primary location and an identity of the at least one person are determined by matching the at least one identifying characteristic and the at least one verified identifying characteristic and verifying the match. Alternatively, the apparatus 10 may be a personal identification and location system, comprising the steps of: an information source module 12 having at least one sensor 16, 18, 20, 24 that provide the following to a sensor validation system 22: a current location, provided by the locator sensor 16; and at least one identifying characteristic, provided by an audio sensor 18, a video sensor 20 and a scanner sensor 24; a data base 30 having the following information about the at least one person: a primary location that includes a location where the at least one person resides; and at least one verified identifying characteristic; and a match verification system 14 having a processor 34, wherein the processor 34 stores: the current and primary locations, the at least one identifying characteristic from the sensor validation system and the at least one verified identifying characteristic in the data base 30; and identifies the at least one person by matching the at least one identifying characteristic of the at least one person and the at least one verified identifying characteristic of the at least one person; and verifies the match.

Hereinafter, “identifying characteristics” include features of a frontal view of a person's face such as, for example, shape and dimensions of a nose, separation of eyes, marks or scars, shape and dimension of eyes, and shape and dimensions of a mouth. Alternatively, the identifying characteristics may be, for example, an iris of an eye, a finger print, a voice print, a Deoxyribonucleic Acid (DNA) chemical analysis or a scent such as a body odor due to chemicals such as pheromones in sweat or other body secretions of the at least one person. Hereinafter “pheromones” are a chemical secreted by an animal, that influences the behavior or development of others of the same species, often functioning as an attractant of the opposite sex.

The first and second computer keyboards 26 and 76, wherein one or both of the keyboards 26 and 76 may be optional, may provide the current location, by, for example, a user typing a U.S. mailing address that includes a street and/or street number, a town or city and a state. Alternatively, the at least one person may provide the current location by typing the U.S. mailing address that includes a street and/or street number, a town or city and a state.

The sensors 16, 18, 20, and 24 may communicate with the sensor validation system (SVS) 22 using data highways 40, 42, 44, and 46 and the SVS 22 may communicate with the match verification system (MVS) 14 using data highways 52, 54, 56 and 58. Alternatively, the communication between the sensors 16, 18, 20, and 24 and the SVS 22 and/or between the SVS 22 and the MVS 14 may be wireless, such as, for example, by radio transmitters and receivers, telephone modems or wide band wide area networks.

A purpose of the sensor validation system 22 is to validate the current location and the at least one identifying characteristic of the at least one person provided by the at least one sensor, i.e., the locator sensor 16; the audio sensor 18; the scanner sensor 24; and the video sensor 26.

Validation may be accomplished by utilizing validation protocols provided by the manufacturer for each of the sensors 16, 18, 24, and 26. For example, if the locator system 16 is a global positioning system (GPS), the system may be validated by determining its error in accordance with procedures described in David L. Wilson's GPS Accuracy Web Page, http://users.erols.com/dlwilson/gps.htm and adjusting the GPS readout such that it accurately reports the current location (i.e. the location of the one or more unidentified persons detected by the sensors 16, 18, 24, and 26). Alternatively, if the video system 26 is a camera, validation is a documented approach, usually provided by a manufacturer, to test the camera to give a high assurance that the equipment will consistently produce results that are within its design specifications. The steps in the validation of cameras can be divided into installation qualification, operational qualification and performance qualification and are described in Fotoflash, Dec. 12, 2000, http://tuck-loong.members.easyspace.com/page40.html.

The locator system 16 includes any appropriate global positioning system (GPS) such as disclosed by Borkowski et al. in U.S. Pat. No. 5,519,760. Borkowski disclosed a cellular network-based location system that includes a mobile station locator entity for receiving from a mobile switching center the network data such as cell and/or sector ID and trunk group member number. The mobile station locator translates the network data into position information such as geographic coordinates (latitude and longitude), resolution (radius), and angle values for sectorized cells. The locator sensor 16 may provide first identifying information about a position of the one or more unidentified persons via data highway 40.

The audio sensor 18 that includes a microphone. The audio sensor 18 may provide at least one identifying characteristic, i.e., voice print data, about at least one person or at least one verified identifying characteristic, i.e., verified voice print data, about the at least one person, wherein the audio sensor 18 includes a microphone to capture and verify voice print data to identify the at least one person as disclosed in U.S. Pat. No. 5,581,630 by Bonneau, Jr. The audio system 18 may provide first identifying information such as the voice print of the one or more unidentified persons via data highway 42.

The video sensor 20 may be any appropriate video system having a camera and a digitizer for converting a frontal image of a person's face into an array of pixel values. The video sensor 20 may provide the at least one identifying characteristic such as the frontal image of the face of the at least one person via data highway 44.

The scanner sensor 24 may be any appropriate optical or acoustic scanner, such as, for example, a fingerprinting scanner, an iris eye scanner, an ultra sound scanner or other acoustic scanner that produces an image in a format that a information verification system having appropriate conversion software may render as a bit map or character recognized file. The bit map may be, for example, a frontal image of a person's face or the character recognized file may be any ASCII file containing alpha numeric characters such as may appear on a check, a credit card or personal identification card. The scanner sensor 28 may be an optical media imaging system as disclosed by Bonneau, Jr., U.S. Pat. No. 5,581,630, herein incorporated by reference. Specifically, the scanner sensor 28 may include an optical reader, having circuitry for reading information from the portable optical media card, such as a credit card, an image scanner; an image system processor, including an encoder connected to the image scanner, and a comparator connected to the encoder and the optical reader; and transaction completion circuitry connected to the comparator. Alternatively, the scanner sensor 24 may be a chemical analyzer such as a spectrophotometer that measures absorption or reflection of light energy by Deoxyribonucleic Acid (DNA) or by a scent or body odor producing chemical such as pheromones in sweat or chemicals in other body secretions of the at least one person. The scanner sensor 24 may provide the at least one identifying characteristic of the one or more unidentified persons such as a fingerprint scan, a DNA code, a chemical analysis of the body odor scent or other chemicals in body secretions, the iris eye scan, the ultra sound scan or other acoustic scan of the one or more unidentified persons via data highway 46.

The sensor validation system 22 may provide validated information to the match verification system (MVS) 14, using data highways 52, 54, 56, and 58 for information from the sensors 16, 18, 20 and 22, respectively. The first computer keyboard 26 and first password enabled entry system 28 may provide verified primary location and at least one verified identifying characteristic to the match verification system 14 in the following way.

The first and second computer keyboard 26 and 76 may be any appropriate alpha-numeric or numeric computer keyboards having a keyboard for data entry and a first password enabled entry system 28. For example, an alpha-numeric keyboard may be a model No. PER-42-011-00 obtained from Bar Code Discount Warehouse, Inc., 2950 Westway Drive, Suite 110, Brunswick, Ohio 44212. In one embodiment, data entry into the match verification system 14 is limited to entry of data by users who know a password. The first password enabled entry system 28 provides verification of the information entered into the system 14 because the password may only be disclosed to users who have agreed to only enter verified data. For example, a user could enter a current location such as, for example, a location, for example, the U.S. post office address of the one or more unidentified persons into the MVS 14 to enable ascertaining the current location of the one or more unidentified persons. Alternatively, the current location may be a pump number, designating one or more gas pumps at a gas station. In one embodiment, the user may be a store clerk, a gas station attendant or a post office clerk, where the one or more unidentified persons may be using the personal identification apparatus 10 at a store display, gas pump or mailbox. The first computer keyboard 26 may provide the current location, or the at least one identifying characteristic to the first password enabled entry system 28 via data highway 48 and the first password enabled entry system 28 may provide the verified current location, or the at least one identifying characteristic to the match verification system (MVS) 14 via data highway 50.

Referring to FIG. 1A, the match verification system (MVS) 14 comprises: a data base 30; a processor 34; a display 32; a modem 36; an optional wide area network 38; and an optional second computer keyboard 76 and optional second password enabled entry system 78.

FIG. 1B depicts a person 140, an apparatus 110 frequented by the person 140 and the apparatus 10 of FIG. 1A after a user interface 120 has been interfaced to the information source module 12 of the apparatus 10. The apparatus 110 frequented by the person 140 may be a gas pump, a mailbox or a dispensing device in a store, wherein the dispensing device dispenses purchasable goods or services. The person 140, for example, may be one or more identified or unidentified persons. Hereinafter, the one or more identified persons is a person whose identity is based on any legally verifiable record of certain at least one identifying characteristic such as, for example, a passport, a driver's license, a birth certificate, a fingerprint record taken from a hand 142 of the person 140 or facial features 141 such as size and/or shape of the person's nose, mouth, chin, forehead, eyebrows, eyes, ears, color of eyes, and/or an iris scan. Hereinafter, a legally verifiable record is one authorized by the laws of the United States or any state law of one of the states in the United States. Hereinafter, the one or more unidentified persons is a person whose identity has not been validated by matching his or her at least one identifying characteristic with the legally verifiable record of his or her respective at least one identifying characteristic. The user interface 120 may comprise: a locator sensor 130; a first computer keyboard 136; a video sensor 138; an audio sensor 146; and a scanner sensor 144; wherein the locator sensor 130 is the locator sensor 16; the first computer keyboard 136 is the first computer keyboard 26; the video sensor 138 is the video sensor 20; the audio sensor 146 is the audio sensor 18; and the scanner sensor 144 is the scanner sensor 24 of the information source module 12, as depicted in FIG. 1A and described herein. The locator sensor 130 may be a circuit containing an erasable programmable read only memory (EPROM) chip having an address of the apparatus 110 frequented by the person 140 programmed into the chip such as a street number, town or city, and state where the apparatus 110 frequented by the person 140 may be located. The first computer keyboard 136 may be an alpha-numeric keypad, a numeric keypad or any appropriate keyboard, the video sensor 138 may be, for example, a camera, the audio sensor 146 may be any appropriate combination speaker and/or microphone, and the scanner sensor 144 may be any optical, magnetic or barcode reader. The locator sensor 130 may communicate with the sensor validation system 22 of the information source module 12 using data highway 40. The first computer keyboard 136 may communicate with the first password enabled entry system 28 of the information source module 12 using data highway 48. The video sensor 138 may communicate with the sensor validation system 22 of the information source module 12 using data highway 44. The audio sensor 146 may communicate with the sensor validation system 22 of the information source module 12 using a data highway 42. The scanner sensor 144 may communicate with the sensor validation system 22 of the information source module 12 using data highway 46. The user interface 120 may be within about a 0 ft. to about a 10 ft. radius of the apparatus 110 frequented by the unidentified person 140, such that the facial features 141 of the at least one person 140 may be in a field 143 of effective operation of the sensors 18, 20, and 22 or 138, 144, 146, as depicted in FIGS. 1A-1C. Alternatively, the user interface 120 may be attached to the apparatus 110 frequented by the person 140. The keypad 136 may be any alpha numeric keypad or a numerical keypad such as a Targus USB Mini Calculator/Keypad, item no. PAUK001U available from Targus Inc., 1211 North Miller Street, Anaheim, Calif. 92806. The camera 138 may be a Panasonic Lumix™ Digital Camera with Leica DC Vario-Elmarit Lens, 1.5″ LCD Monitor, USB port, and editing software, available from local Panasonic dealers or retailers.

Referring to FIG. 1B, the processor 34 of the match verification system 14 may be a computer processor having software for driving the display 32, such that a button 35 may be represented on the display 32. The button 35 may be part of a circuit 98, wherein a signal or electrical power may be sent to a controller 97 on the apparatus 110, indicating the apparatus 110 may operate when a user may authorize operation of the apparatus 110 by touching or depressing the button 35 of the display 32 or clicking on the button 35 using a cursor of the display 32. Authorization may allow the apparatus 110 to pump gas, open a mailbox door, or provide an article to a customer in a store.

FIG. 1C depicts FIG. 1B, after a combination speaker and/or microphone 150 of a user interface 128 has been operably coupled using data highways 122 and 124 to the combination speaker and/or microphone 146 of the user interface 120 and one or more user interfaces 128 has been interfaced to the match verification system 14 of the apparatus 10. The user interface 128 may comprise: a second computer keyboard 152, a combination speaker and/or microphone 150, a display 118, wherein the second computer keyboard 152 is the second computer keyboard 76; the display 118 is the display 32 of the match verification system 14 of the apparatus 10. The second computer keyboard 152 may be any appropriate alpha-numeric or numeric keyboard. The display 118 may be any computer monitor or smart screen, wherein the processor 34 is equipped with appropriate driver and software for viewing images or text from the processor 34 such as a Wanpipe™ driver and software commercially available from Sangoma Technologies, Inc., Markham Ontario, L3R 9T3, CANADA. The display 118 may be any computer monitor or smart screen having appropriate driver and software for presenting a grid on the screen superimposed over the images and text, such that a user of the personal identification system 10 may verify a match made by the match identification system 14 by, for example, touching, i.e., applying pressure to a picture of the at least one person 140 on the display 118 with the user's fingertip. If the match is verified, a user of the apparatus 10 may authorize the apparatus 110 to pump gas, open a mailbox door, or provide an article to a customer in a store.

The second computer keyboard 152 may communicate with the second password enabled entry system 28 using data highway 82. The display 118 may communicate with the processor 34 using data highways 62 and 64. The combination microphone and/or speaker 150 may communicate with the combination microphone and/or speaker 146 of the user interface 120 using data highways 122 and 124.

Referring to FIG. 1C, the processor 34 of the match verification system 14 may be a computer processor having software for driving the display 118, such that a button 37 may be represented on the display 118. The button 37 may be part of a circuit 98, wherein a signal or electrical power may be sent to a controller 97 on the apparatus 110, indicating the apparatus 110 may operate when a user may authorize operation of the apparatus 110 by touching or depressing the button 37 or clicking on the button 37 using a cursor of the screen 118. Authorization may allow the apparatus 110 to pump gas, open a mailbox door, or provide an article to a customer in a store.

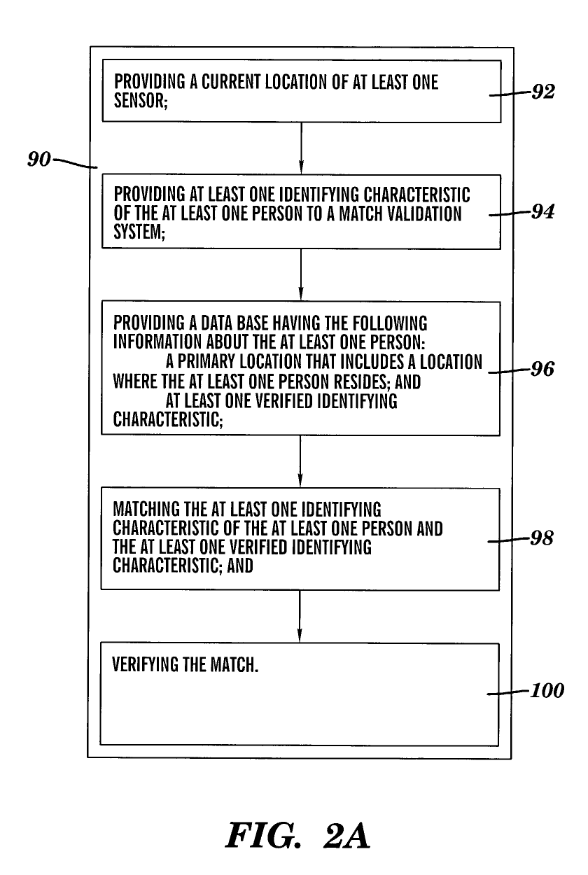

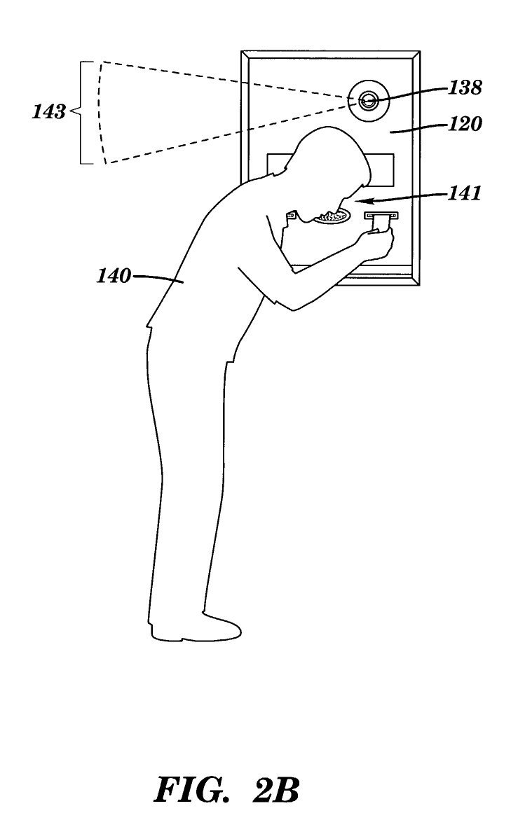

FIG. 2A depicts a method 90 for identifying and locating at least one person 140, as depicted in FIGS. 1A-1C, comprising the steps of: step 92, providing a current location, provided by a locator sensor 16, as depicted in FIG. 1A or 130 as depicted in FIGS. 1B-1C, of at least one sensor 18, 20, 24, as depicted in FIG. 1A or the at least one sensor 130, 138, and 144 as depicted in FIGS. 1B-C; step 94, providing at least one identifying characteristic of the at least one person 140 to the match validation system 14; step 96, providing a data base 30 having the following information about the at least one person 140: a primary location that includes a location where the at least one person resides; and at least one verified identifying characteristic; step 98, matching the at least one identifying characteristic of the at least one person and the at least one verified identifying characteristic; and step 100, validating the match.

In the step 92 of the method 90, the current location of the locator sensor 16, as depicted in FIG. 1A or 130 as depicted in FIGS. 1B-1C, of at least one sensor 18, 20, 24, as depicted in FIG. 1A or the at least one sensor 130, 138, and 144 as depicted in FIGS. 1B-C may be provided by a global positioning system (GPS) or a circuit containing an erasable programmable read only memory (EPROM) chip having an address of the apparatus 110 frequented by the person 140 programmed into the chip such as a street number, town or city, and state where the apparatus 110 frequented by the person 140 may be located. Alternatively, the current location may be provided by the person 140 using the first computer keyboard 136 as depicted in FIGS. 1B-1C.

In the step 94 of the method 90, the at least one identifying characteristic of the at least one person 140 may be validated by the sensor validation system 22 and the validated sensor information may be provided to the match validation system 14 by the sensors 18, 20 and 24 as depicted in FIG. 1A or by the sensors 138, 144 and 146 as depicted in FIGS. 1B-1C.

FIG. 2B depicts the interface 120 having a video sensor 138 such as, for example, a camera, wherein the person 140 has moved his or her at least one identifying characteristic, i.e. his or her facial features 141 out of the field 143 of effective operation of the sensor 138. The sensor 138, i.e. the camera, will no longer see the facial features 141 of the at least one person 140. The sensor validation system 22 may validate the at least one identifying characteristic of the at least one person 140 by testing, for example, if the sensor is a camera, the image received by the sensor validation system 22. Only if the image satisfies the test will the sensor validation system 22 validate the image. Alternatively, the sensors 18, 20 and 24 as depicted in FIG. 1A or by the sensors 138, 144 and 146, as depicted in FIGS. 1B-1C, for example, a camera may provide an image to the display 32 of the interface 128, as depicted in FIG. 1C. In one embodiment a user may look at the facial features 141 of the at least one person 140 and validate the image such as, for example, by applying pressure to a button on the display if the display is a smart screen.

In FIG. 2B, the facial features 141 of the at least one person 140 is not in the field 143 of the effective operation of, for example, the video sensor 138. Neither the validation system 22 nor the user of the display 32 will validate the at least one identifying characteristic from the video sensor 138, if the characteristics are not in the field 143 of the sensors 18, 20, 24, 130, 138, and 144.

Referring to FIG. 2A, in step 96 of the method 90, a primary location that includes a location where the at least one person reside; and at least one verified identifying characteristic may be provided to the match verification system 14. The primary location may be an street number, town, city and state in the world where a person 140 may reside. The primary location may be obtained from any legally verifiable record. The primary location may include the street number, town, city and state in the world where a relative of the one or more person 140 may reside. Verified identifying characteristics of the one or more person 140 may also be obtained from any legally verifiable record such as a picture on a state issued motor vehicle license or a physical description on a birth certificate. Alternatively, verified at least one identifying characteristic may be provided by police photos, blood types, fingerprints, iris images, and DNA profiles.

Referring to FIG. 2A, in step 98 of the method 90, the at least one identifying characteristic of the at least one person and the at least one verified identifying characteristic may be matched to identify the at least one person 140. Okano et al., in U.S. Pat. No. 6,404,903, herein incorporated by reference, disclosed a system for identifying individuals by comparing an input image with a recognition dictionary. If the identification result is that the input image partially differs from the dictionary image, the input image and the discordant portion is displayed.

Referring to FIG. 2A, in step 100 of the method 90, the match is verified. The identifying characteristics of the at least one person 140 from the sensors 18, 20, 24, 130, 144, and 146 may be displayed on the display 32 or 118, as depicted in FIGS. 1A-C. The respective verified identifying characteristics of the at least one person 140 may, in like manner, be displayed on the displays 32 or 118. In one embodiment, the at least one verified identifying characteristic are the characteristics taken from legal records, described herein. The verification may be based on a user comparing the identifying characteristics of the at least one person 140 and the verified identifying characteristics and rationalizing or explaining the presence of a discordant portion, such as being due to a known change in the at least one person 140 identifying characteristics. Alternatively, the match is verified if there is no discordant portion.

Whether the match is verified may be a test for a user of the personal identification system 10 to authorize operation of the apparatus 110. If the match is verified, the user may authorize operation of the apparatus 110 by touching or depressing the button 35, or clicking on the button 35 using a cursor of the display 32, as depicted in FIG. 1B, or the button 37 on the display 118, as depicted in FIG. 1C.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

I claim:

1. An apparatus for identifying and locating at least one person, comprising:
at least one sensor, wherein the at least one sensor provides the following information about the at least one person to a sensor validation system:
a current location; and
at least one identifying characteristic;
a data base having the following information about the at least one person:
a primary location that includes a location where the at least one person resides; and
at least one verified identifying characteristic; and
a match verification system, wherein the primary location and an identity of the at least one person is determined by matching the at least one identifying characteristic and the at least one verified identifying characteristic and verifying the match.

2. The apparatus of claim 1, wherein the current location includes a U.S. mail address of a mailbox.

3. The apparatus of claim 1, wherein the current location includes a pump number or a U.S. mail address of a gas station.

4. The apparatus of claim 1, wherein the at least one identifying characteristic is provided by a camera or a scanner.

5. The apparatus of claim 1, wherein the primary location is a residence of a family member of the at least one person.

6. The apparatus of claim 1, wherein the at least one identifying characteristic includes a frontal view of the at least one person.

7. The apparatus of claim 1, wherein the sensor information is validated.

8. A personal identification and location system, comprising:
an information source module having at least one sensor that provides the following to a sensor validation system:
a current location; and
at least one identifying characteristic;
a data base having the following information about the at least one person:
a primary location that includes a location where the at least one person resides; and
at least one verified identifying characteristic; and
a match verification system having a processor, wherein the processor stores:
the current and primary locations, the at least one identifying characteristic from the sensor validation system and the at least one verified identifying characteristic in the data base; and
identifies the at least one person by matching the at least one identifying characteristic of the at least one person and the at least one verified identifying characteristic of the at least one person; and
verifies the match.

9. The apparatus of claim 8, wherein the current location includes a U.S. mail address of a mailbox.

10. The apparatus of claim 8, wherein the current location includes a pump number or a U.S. mail address of a gas station.

11. The apparatus of claim 8, wherein the at least one identifying characteristic is provided by a camera or a scanner.

12. The apparatus of claim 8, wherein access to the data base requires a password.

13. The apparatus of claim 8, wherein the primary location is a residence of a family member of the at least one person.

14. The apparatus of claim 8, wherein the at least one identifying characteristic includes a frontal view of the at least one person.

15. A method for identifying and locating at least one person, comprising the steps of:
providing a current location of at least one sensor;
providing at least one identifying characteristic of the at least one person to a match verification system;
providing a data base having the following information about the at least one person:
a primary location that includes a location where the at least one person resides; and
at least one verified identifying characteristic;
matching the at least one identifying characteristic of the at least one person and the at least one verified identifying characteristic; and
verifying the match.

16. The method of claim 15, wherein the current location is a U.S. mail address of a mailbox.

17. The method of claim 15, wherein the current location is a pump number or a U.S. mail address of a gas station.

18. The method of claim 15, wherein the at least one identifying characteristic is provided by a camera or a scanner.

19. The method of claim 15, wherein the primary location is a residence of a family member of the at least one person.

20. The method of claim 15, wherein the at least one identifying characteristic includes an iris image or a fingerprint.
